(19) United States
(12) Patent Application Publication
(10) Pub. No.: US 2015/0258533 A1
(43) Pub. Date: Sep. 17, 2015

(54) COMPONENT FOR HIGH-TEMPERATURE APPLICATIONS, METHOD FOR THE PRODUCTION THEREOF, AND USE THEREOF

(71) Applicants: Mihails Kusnezoff, Dresden (DE); Nikolai Trofimenko, Dresden (DE); Chriffe Omar Belda, Dresden (DE); Egle Dietzen, Dresden (DE); Ulrich Guth, Greifswald (DE); Uladzimir Vashuk, Dresden (DE)

(72) Inventors: Mihails Kusnezoff, Dresden (DE); Nikolai Trofimenko, Dresden (DE); Chriffe Omar Belda, Dresden (DE); Egle Dietzen, Dresden (DE); Ulrich Guth, Greifswald (DE); Uladzimir Vashuk, Dresden (DE)

(73) Assignees: Fraunhofer-Gesellschaft Zur Foerderung Der Angewandten Forschung E. V., Muenchen (DE); TECHNISCHE UNIVERSITAT DRESDEN, Dresden (DE)

(21) Appl. No.: 14/234,216

(22) PCT Filed: Jul. 17, 2012
(86) PCT No.: PCT/EP2012/064026

§ 371 Date: May 7, 2014

(30) Foreign Application Priority Data
Jul. 22, 2011 (DE) 10 2011 108 620.3

(51) Int. Cl. B01J 23/83; G01N 27/30; C25B 11/04; H01M 4/90; H01M 8/12

(52) U.S. Cl. CPC B01J 23/83; H01M 4/9033; H01M 8/1246; C25B 11/0452; G01N 27/304; H01M 2008/1293; H01M 2300/0074

(57) ABSTRACT

The invention relates to a component for high-temperature applications, to a method for the production thereof and to a use thereof. In this respect, an electrical conductivity and a catalytic effect should be achievable with a simultaneous chemical and thermal resistance under different conditions and also at temperatures above 700° C. The component in accordance with the invention is formed from a body which is formed from Ce1-x-yLnxMeyO2. In this respect, Ln is a rare earth metal and Me is a transition metal, where x=0.01 to 0.25 and y=0.05 to 0.2. Particles having a mean particle size in the range from 5 nm to 500 nm, preferably in the range from 10 nm to 300 nm, and formed using transition metal, are present in a distributed arrangement on at least one surface.

The invention relates to a component for high-temperature applications, to a method for the production thereof and to a use thereof. In this respect, an electrical conductivity and a catalytic effect should be achievable with a simultaneous chemical and thermal resistance under different conditions and also at temperatures above 700° C. For applications in SOFCs or as a membrane, a porosity suitable for this purpose should be able to be present which allows a gas permeability. In particular on a use for anodes of SOFCs, an adaptation of the thermal expansion to other adjacently arranged elements is also desirable.

It has long been known that high-temperature fuel cells, which also include SOFCs, are capable of being able to provide electrical energy by an electrochemical reaction using hydrocarbon compounds and this is optionally also possible with a high efficiency while dispensing with an upstream reformer. In this respect, the problem of the sulfur contained in a fuel which is used must also be taken into account.

So-called cermets, that is mixtures of metal with a ceramic material, have frequently been used up to now. They are thermally and mechanically stable at the high temperatures and achieve a sufficient electrical conductivity. Nickel, cobalt or precious metals can be used as metals. Suitable ceramics are yttrium stabilized zirconia (YSZ) or ceria doped with Sm or Gd (SDC or GDC) can also be used.

The proportions are selected such that an adaptation of the thermal coefficient of expansion to other components of high-temperature fuel cells can be achieved. Nickel is present as a metal at an anode of a fuel cell during the operation of fuel cells.

However, the agglomeration of the nickel in the cermet during the fuel cell operation is problematic. The electrochemical reaction in high-temperature fuel cells takes place at the three-phase boundary where nickel, the ceramic component and pores of the cermet come into contact with one another. The catalytic effect is given in the continuous network of the three phases of the cermet network. The nickel agglomeration reduces the available three-phase boundary, whereby the polarization resistance of the anode increases.

A further problem is the susceptibility of the anodes for other chemical components, such as in particular sulfur and sulfur compounds, contained in the fuel, methane for example. In this case, sulfur is chemisorbed and blocks active centers of catalysts. The catalytic activity thereby deteriorates in the long term, whereby an electrical performance loss and a reduction in the efficiency occur.

There are approaches to use metallic mixed oxides (perovskites) as the anode material. Anodes formed from perovskites, however, have previously not reached the required polarization resistances.

It is therefore the object of the invention to provide a component for high-temperature applications which has and permanently maintains a high catalytic efficiency in electrochemical processes which can be manufactured inexpensively.

In accordance with the invention, this object is achieved by a component having the features of claim 1. It can be manufactured using a method in accordance with claim 5. Advantageous uses are listed in claim 9.

The component in accordance with the invention for high-temperature applications is formed from a body which is formed from Ce1-x-yLnxMeyO2-d, wherein Ln is a rare earth metal, Me is a transition metal and x=0.01 to 0.25 and ^{y=}0.05 to 0.2. Particles having a mean particle size in the range from 5 nm to 500 nm, preferably in the range from 10 nm to 300 nm, and formed using transition metal, are present in a distributed arrangement on the oxide phase surface due to the manufacture.

In this respect, the rare earth metal Ln can be selected from Sm, Y, La, Yb and Gd and the transition metal can be selected from Ni and Cu.

The manufacture takes place in two major method steps. In a first method step, a mixture which is formed using chemical compounds and in which chemical compounds in which Ce, at least one rare earth metal Ln and at least on transition metal Me are contained, is subjected to a thermal treatment at a temperature of at least 400° C. In this respect, while maintaining an atmosphere containing oxygen, a mixed oxide of the composition Ce1-x-yLnxMeyO2-d, with Ln as the rare earth metal, Me as the transition metal and x=0.01 to 0.25, y=0.05 to 0.2 was applied. In the stoichiometric mixed oxide Ce1-yLnyO2-d, the oxygen stoichiometry d is calculated from the formula:

d=x/2 Ce1-xLnxO2-d=(CeO2)1-x(LnO1.5)x=Ce1-xLnxO2-x/2.

The oxygen stoichiometry is also dependent on the oxygen partial pressure.

In addition, components, in particular organic components, already contained in the chemical compounds are removed.

A fluorite phase without secondary phases is formed in the mixed oxide in this method step.

In the second method step, a thermal treatment is carried out at a temperature of at least 800° C. while maintaining a reducing atmosphere, preferably hydrogen. In this respect, metallic particles of transition metal Me having a mean particle size in the range from 5 nm to 500 nm, preferably in the range from 10 nm to 300 nm, are formed in a distributed arrangement on the surface exposed to the reducing atmosphere.

In this method step, a two-phase compound of the mixed oxide with a fluoride structure and at least one metallic phase of the transition metal is formed under reducing conditions. A three-dimensional crystal structure having a specific arrangement of the atoms in the grid can be understood as the fluorite structure. Such structures likewise occur in materials without fluorine in the crystal lattice. This is also the case e.g. with yttrium stabilized zirconia.

In this respect, a two-phase structure of the material is preferred for the component in accordance with the invention in which particles having a particle size in the nanometer range have been formed from nickel or from another transition metal and are arranged distributed uniformly over the surface at the surface of a cerium samarium/gadolinium oxide compound. It is also not an obstacle when a residual portion of the transition metal remains dissolved in the oxide compound and is not reduced to a pure metal. The metal particles formed on the surface maintain their good bond to the oxide compound.

A high catalytic efficiency can thereby be achieved in cyclic oxidation/reduction processes and an agglomeration formation can be avoided.

Carboxylates or transition metal carboxylates, acetate hydrates and/or nitrates can be used as chemical compounds in which transition metals Me are contained for the manufacture of the composition Ce1-x-yLnxMeyO2-d.

In the first method step, the mixed oxide should be formed in the thermal treatment in the form of a solid solution.

The manufacture advantageously takes place over a sol/gel synthesis. A saline solution in which an aqueous citric acid solutions, a multivalent alcohol (preferably ethylene glycol), transition metal hydrate, rare earth nitrate, are contained in a suitable molar ratio is manufactured for this purpose. After a complete solution of the solid components, a thickening can be achieved on a heating to approximately 100° C. In this respect, an esterification of the alcohol with carboxylic acid takes place which produces a gel formation. Cations and anionic components of the salts used are present in the gel. This dried gel can then be subjected to the first method step. The larger part of the contained organic components and the anionic components are oxidized. Ce1-x-yLnxMeyO2 or (CeO2)1-x-y (LnO1.5)x(MeO1.5)y are formed. In this respect, a very small grain size, crystallinity and homogeneity are achieved. Only small portions of carbon remain.

If it is necessary for the respective application, the crystallinity can be increased and the portion of the organic contaminants can be reduced in that a further thermal treatment is carried out in an atmosphere containing oxygen at higher temperatures up to around 900° C. over a longer period, preferably of around 5 h. In this respect, a corresponding single-phase Ce1-x-yLnxMeyO2 can be formed.

In the second method step, hydrogen can be used for the reduction of nickel or of another transition metal. This thermal treatment in a reducing atmosphere can be carried out over a period of 1 h to 5 h, preferably 3 h. In this respect, the mentioned two-phase material can be formed with a fluorite structure and the metal particles at the surface. The largest part of the originally present transition metal forms the nanoparticles on the surface and a smaller remainder remains in the lattice of the fluorite structure.

A component having a high catalytic efficiency with a high specific surface can be provided by the invention. They also do not change during normal conditions of use in the high-temperature range above 700° C.

During manufacture, influence can be taken on the size of the metal particles formed on the surface by an adaptation of the maximum temperature during the second method step. Larger particles can thus be obtained when the temperature is higher than 1200° C. and smaller particles are formed at a lower maximum temperature.

Components in accordance with the invention can be used for anodes of a solid oxide fuel cell, anodes of a solid oxide electrolysis, anodes for electrochemical oxygen pumps, for oxygen sensors, as a catalyst for the reforming of hydrocarbon compounds or as a surface catalyst for membranes permeable to oxygen. For these uses, the component can be manufactured from three phases, namely a metallic phase, an oxidic phase and a third phase as a composite. The third phase can be a perovskite which is electrochemically inert and which can form a matrix for the two other phases.

The invention will be explained in more detail by way of example in the following.

A saturated solution of citric acid in deionized water having 125.1 g is used for the manufacture of a component in accordance with the invention of Ce1-x-yLnxNiyO2 in which Sm and/or Gd are used as the rare earth metal (Ln). 236.6 g citric acid monohydrate can be used for this purpose. 9.332 g nickel(II) acetate hydrates Ni(OOCCH3)2*4H2O, 5.558 g samarium nitrate hydrate Sm(NO3)3*6H2O and 86.931 g cerium nitrate hydrates Ce(NO3)3×6H2O corresponding to the molar ratio of the target composition Ce0.85m0.05Ni0.15O2-d can be added into this solution and dissolved while stirring.

In this respect, the molar ratio of the chelating agent (citric acid) to cations amounts to 4.5:1 in a bimolar solution (with respect to a total cation concentration).

In addition to the citric acid, 280 g ethylene glycol is added to the solution as multivalent alcohol. In this respect, a molar ratio of citric acid to alcohol of 1:4 is observed.

The solution in which all elements were completely dissolved was then heated to around 100° C. to achieve a gel formation with a simultaneous esterification of ethylene glycol and carboxylic acid. Cations and anionic elements of the salts used are contained in a solid polyester (gel) in the solution thickened in this manner.

The gel of the salt solution pretreated in this manner was subjected to the first method step with the thermal treatment in an atmosphere containing oxygen (air) at a temperature of 400° C. for 1 h. Ce1-x-ySmxNiyO2 was formed as the oxidic product. Only traces of residual carbon were still contained.

In a second method step, the obtained mixed oxide was subjected to a thermal treatment in a hydrogen atmosphere at a temperature of 1000° C. to 1300° C., preferably 1250° C., for 3 h. Ce1-x-ySmxNiyO2 with a fluorite structure was formed and particles of nickel with a particle size in the range of 10 nm to 300 nm lay in uniform distribution as the second phase at the surface exposed to the hydrogen. A residue of nickel remained in the lattice of the fluorite structure. The proportion was, however, below or close to the detection limit.

Molar ratios had to be observed for cerium nitrate hydrate of 0.7 to 0.98, for samarium nitrate hydrate from 0.01 to 0.25 and for nickel acetate hydrate from 0.05 to 0.2, with respect to the stoichiometric formula (CeO2)1-x-y(LnO1.5)x(MeO1.5)y.

1. A component for high-temperature applications which is formed from a body which is formed from Ce1-x-yLnxMeyO2 and where Ln is a rare earth metal, Me is a transition metal and x=0.01 to 0.25 and y=0.05 to 0.2 and particles formed at at least one surface with transition metal are present in a distributed arrangement with a mean particle size in the range from 5 nm to 500 nm, preferably in the range from 10 nm to 300 nm.

2. A component in accordance with claim 1,
characterized in that
the rare earth metal Ln is selected from Sm, Y, La, Yb and Gd and
the transition metal is selected from Ni and Cu.

3. A component in accordance with claim 1,
characterized in that
it is formed as a two-phase composite having a metallic phase and an oxidic phase.

4. A component in accordance with claim 1,
characterized in that
it is formed as a three-phase composite in which a third phase is contained in addition to a metallic phase and an oxidic phase.

5. A method of manufacturing a component in accordance with claim 1,
characterized in that,
in a first method step, a mixture which is formed using chemical compounds in which chemical compounds in which Ce, at least one rare earth metal Ln and at least one transition metal Me are contained, is subjected to a thermal treatment at a temperature of at least 400° C., in which thermal treatment, while maintaining an atmosphere containing oxygen, a mixed oxide of the composition Ce1-x-yLnxMeyO2-δ is formed with Ln as the rare earth metal and Me as the transition metal and where x=0.01 to 0.25 and y=0.05 to 0.2 and where components, in particular organic components, previously contained in the chemical compounds are removed; and
in a second method step, a thermal treatment is carried out at a temperature of at least 800° C. while maintaining a reducing atmosphere in which metallic particles of transition metal Me having a mean particle size in the range from 5 nm to 500 nm, preferably in the range from 10 nm to 300 nm, are formed in a distributed arrangement on the surface exposed to the reducing atmosphere.

6. A method in accordance with claim 4,
characterized in that,
in the first method step, the mixed oxide is formed in the thermal treatment in the form of a solid solution.

7. A method in accordance with claim 4,
characterized in that
salts having acetates, acetate hydrates and/or nitrates are used as the chemical compound in which the transition metal Me is contained.

8. A method in accordance with claim 4,
characterized in that
an aqueous solution of citric acid and ethylene glycol is used for water-soluble chemical compounds in which a transition metal Me is contained.

9. Use of a component in accordance with claim 1 as an anode for a solid oxide fuel cell, an anode of a solid oxide electrolysis cell, an anode for an electrochemical oxygen pump, for oxygen sensors, as a catalyst for the reforming of hydrocarbon compounds, as a catalyst and oxygen store for a cyclic oxidation/reduction or as a surface catalyst for membranes permeable to oxygen.
